(19) United States
(12) Patent Application Publication
(10) Pub. No.: US 2012/0156978 A1
(43) Pub. Date: Jun. 21, 2012

(54) CLEAN WORKTABLE

(75) Inventors: PENG KUANG, Shenzhen City (CN); ZENG-QUN CHENG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/213,260

(22) Filed: Aug. 19, 2011

(30) Foreign Application Priority Data
Dec. 21, 2010 (CN) 201010598593.8

(51) Int. Cl. B08B 15/02

(52) U.S. Cl. 454/57

(57) ABSTRACT

A clean worktable includes a support body, a work platform, a bellows, a front workspace, and a second workspace. The work platform and the bellows are positioned on the support body. The front workspace is opposite to the back workspace. The work platform has a first region in the front workspace and a second region in the back workspace. The bellows provides airflow to the first region and the second region for removing dust and the clean worktable enables two workers to function simultaneously.

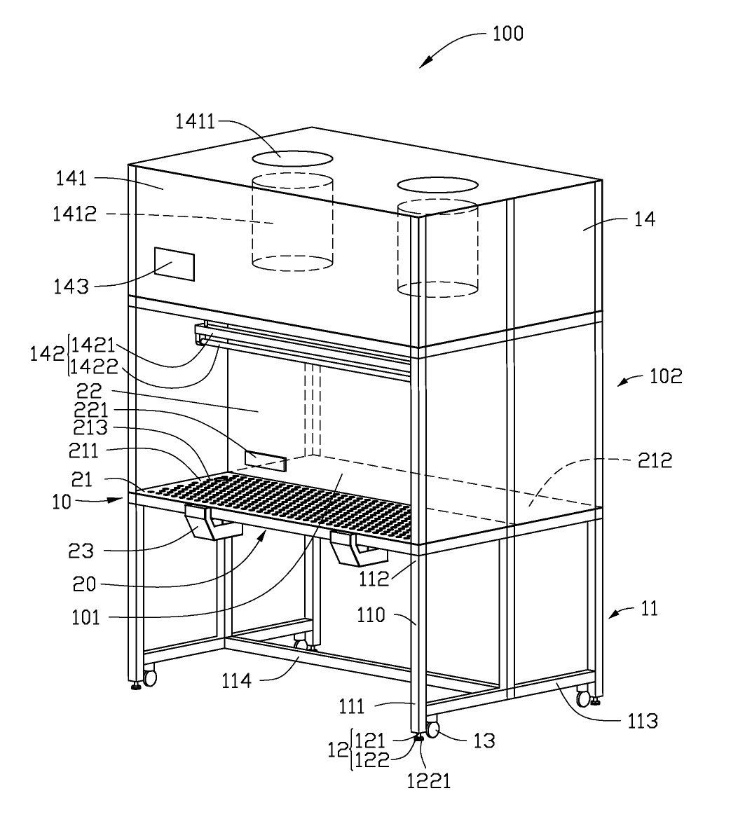

### BACKGROUND

1. Technical Field

The present disclosure generally relates to clean worktables, and particularly, to a clean worktable providing two workspaces.

2. Description of the Related Art

A clean worktable complete with air purification equipment, provides a clean, sterile working environment, and can dispose of contaminated air to the outside through a special filtering channel, thereby preventing harm to people and the environment. The clean worktable typically includes a support frame, a work platform supported by the support frame, a light source, and a bellows positioned on the support frame. The bellows generates a clean airflow to remove dust. The clean worktable is generally placed in a clean room. When a plurality of clean worktables are positioned in one clean room, the clean room must be sufficiently large to accommodate all of the clean worktables. As a result, the cost and maintenance costs of the clean room are relatively high.

Therefore, there is room for improvement within the art.

### BRIEF DESCRIPTION OF THE DRAWING

The components in the drawings are not necessarily drawn to scale, the emphasis instead being placed upon clearly illustrating the principles of the present disclosure.

The FIGURE shows an isometric view of an embodiment of a clean worktable.

### DETAILED DESCRIPTION

Referring to the FIGURE, an embodiment of a clean worktable 100 includes a support frame 10 and a work platform 20 fixed on the support body 10. The clean worktable 100 further includes a front workspace 101 and a back workspace 102 opposite to the front workspace 101.

The support body 10 includes a support frame 11, a plurality of adjusting mechanisms 12, a plurality of rollers 13, and a top body 14. The adjusting mechanisms 12 are fixed to the bottom of the support frame 11 for supporting the support frame 11. The rollers 13 are fixed to the bottom of the support frame 11, and each roller 13 is adjacent to one corresponding adjusting mechanism 12. The top body 14 is fixed on the top of the support frame 11.

The support frame 11 includes a plurality of support poles 110. Each support pole 110 includes a connecting end 111 connected to the adjusting mechanism 12, and a support end 112 connected to the work platform 20. The support frame 11 further includes two first connecting poles 113 interconnecting the connecting ends 111 of the support poles 110, and a second connecting pole 114 interconnecting the two first connecting poles 113. Each connecting end 111 defines a threaded hole (not shown). Each adjusting mechanism 12 includes a threaded support rod 121 threadedly engaged in the threaded hole of the connecting end 111, and a support base 122 connected to the threaded support rod 121. The depth of the threaded support rod 121 which is threadedly engaged in the support pole 110 can be adjusted. The support base 122 has a support surface 1221. The threaded support rod 121 and the support base 122 can be integrally formed.

Each roller 13 is positioned on the first connecting poles 113 and adjacent to the connecting ends 111 of the support poles 110. When each threaded support rod 121 is in a first position relative to the support pole 110, the clean worktable 100 is supported by the adjusting mechanisms 12. When each threaded support rod 121 is in a second position relative to the support pole 110, the clean worktable 100 is supported by the rollers 13, and can be easily moved.

The top body 14 includes a bellows 141, a light source 142 positioned below the bellows 141, and a control panel 143 positioned on a side of the bellows 141. The control panel 143 contains the means of operating the clean worktable 100 and displays certain operating parameters. The bellows 141 includes two fans 1412 inside the bellows 141, and defines two vents 1411 in the top surface thereof. The fans 1412 take in outside air into the bellows 141 via the vents 1411, and the bellows 141 filters the outside air. The filtered air flows downwards onto the work platform 20, thereby removing dust on the work platform 20.

The light source 142 includes a positioning frame 1421 and a lamp 1422 positioned on the positioning frame 1421. The height of the lamp 1422 relative to the work platform 20 can be adjusted.

The control panel 143 can show information such as air pressure differences between the inside and the outside of the clean worktable 100, and the flow speed of the filtered air. Therefore, it is easy to monitor the real-time operating parameters of the clean bench 100. In addition, the bellows 141 can further include a static cleaning device, such as an ionizer or ionic air gun.

The work platform 20 includes a support plate 21, a separating plate 22 positioned on the support plate 21, and a receiving assembly 23 detachably positioned on the support plate 21. The support plate 21 includes a first region 211 in the front workspace 101 and a second region 212 in the back workspace 102. The separating plate 22 separates the first region 211 from the second region 212.

The support plate 21 is configured for supporting workpieces (not shown), and defines a plurality of dust removing holes 213. In the illustrated embodiment, the support plate 21 is a metal mesh defining a matrix of dust removing holes 213. The separating plate 22 is substantially perpendicular to the support plate 21. An electric socket 221 can be positioned on the separating plate 22.

The separation provided by the separating plate 22 between the first region 211 and the second region 212 enables operators to work in the front workspace 101 and the back workspace 102 simultaneously without disturbing each other. The receiving assembly 23 is a drawer in the illustrated embodiment.

The clean worktable 100 forms the first front workspace 101 and the second region 212 on opposite sides of the separating plate 22. Therefore, operators can work in the front workspace 101 and the back workspace 102 simultaneously. In addition, the front workspace 101 and the back workspace 102 share the same bellows 141, thus the manufacturing costs of the clean worktable 100 are reduced. The front workspace 101 and the back workspace 102 may in addition share the same light source 142, when the light source 142 is positioned on the separating plate 22.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A clean worktable, comprising:
a support body;
a work platform positioned on the support body;
a bellows positioned on the support body;
a front workspace; and
a back workspace opposite to the front workspace, wherein the work platform has a first region in the front workspace and a second region in the back workspace; the bellows provides airflow to the first region and the second region for removing dust.

2. The clean worktable of claim 1, further comprising a separating plate separating the first region from the second region.

3. The clean worktable of claim 1, wherein the support body comprises a support frame and a plurality of adjusting mechanisms positioned on a bottom of the support frame; the support frame defines a plurality of threaded holes; each adjusting mechanism comprises a threaded support rod threadedly engaged into a corresponding threaded hole of the support frame.

4. The clean worktable of claim 3, wherein the support body further comprises a plurality of rollers positioned on a bottom of the support frame; when each threaded support rod is in a first position relative to the support frame, the clean worktable is supported by the adjusting mechanisms; when each threaded support rod is in a second position relative to the support frame, the clean worktable is supported by the rollers.

5. The clean worktable of claim 1, wherein both the first region and the second region define a plurality of dust removing holes.

6. The clean worktable of claim 5, wherein the work platform further comprises a support plate, which is a metal mesh defining the dust removing holes.

7. The clean worktable of claim 1, wherein the work platform further comprises a receiving assembly detachably positioned on the support plate.

8. The clean worktable of claim 1, further comprising a light source comprising a positioning frame and a lamp positioned on the positioning frame, wherein the positioning frame is positioned below the bellows.

9. The clean worktable of claim 1, further comprising a control panel positioned on a side of the bellows, wherein the control panel shows operating parameters.

10. A clean worktable, comprising:
a support body;
a work platform positioned on the support body;
a bellows positioned on the support body;
a front workspace; and
a back workspace opposite to the front workspace, wherein the front workspace and the back workspace share the bellows, and the bellows provides airflow to the front workspace and the back workspace for removing dust.

11. The clean worktable of claim 10, further comprising a separating plate separating the first region from the second region.

12. The clean worktable of claim 10, wherein the support body comprises a support frame and a plurality of adjusting mechanisms positioned on a bottom of the support frame; the support frame defines a plurality of threaded holes; each adjusting mechanism comprises a threaded support rod threadedly engaged into a corresponding threaded hole of the support frame.

13. The clean worktable of claim 12, wherein the support body further comprises a plurality of rollers positioned on a bottom of the support frame; when each threaded support rod is in a first position relative to the support frame, the clean worktable is supported by the adjusting mechanisms; when each threaded support rod is in a second position relative to the support frame, the clean worktable is supported by the rollers.

14. The clean worktable of claim 10, wherein both the first region and the second region define a plurality of dust removing holes.

15. The clean worktable of claim 14, wherein the work platform further comprises a support plate, which is a metal mesh defining the dust removing holes.

16. The clean worktable of claim 10, wherein the work platform further comprises a receiving assembly detachably positioned on the support plate.

17. The clean worktable of claim 10, further comprising a light source comprising a positioning frame and a lamp positioned on the positioning frame, wherein the positioning frame is positioned below the bellows.

18. The clean worktable of claim 10, further comprising a control panel positioned on a side of the bellows, wherein the control panel shows operating parameters.
